(19) United States
(12) Patent Application Publication
(10) Pub. No.: US 2005/0053731 A1
(43) Pub. Date: Mar. 10, 2005

(54) Decorative patterned apparatus

(76) Inventor: Fu-Chien Lin, Taichung Hsien (TW)

Correspondence Address: Morton J. Rosenberg;Rosenberg, Klein & Lee, Suite 101, 3458 Ellicott Center Drive, Ellicott City, MD, 21043, US

(21) Appl. No.: 10/655,018

(22) Filed: Sep. 5, 2003

(51) Int. Cl. A01N 1/00

(52) U.S. Cl. 428/16

(57) ABSTRACT

The present invention relates to a decorative patterned apparatus, which includes a basic patterned frame composed by rods and connected with bulb assemblies at interval. The improvement of the present invention is to provide a colorful layer to cover the patterned frame. The colorful layer is penetrable to light. The apparatus can thus display the original construction for decorative whenever in the daytime or at night.

### BACKGROUND OF THE INVENTION

A conventional decorative patterned apparatus is designed for obtaining a special decorative effect. For example, as shown in FIGS. 1 and 2, a decorative apparatus is patterned as a deer, which is composed by many rods (11) or iron wire. Many bulb assemblies (2) are combined on the rods (11) at interval. At night, the bulb can emit light to show a clear construction of the patterned apparatus that provides a beautiful outlook. But in the daytime, the patterned apparatus is only a hollow frame. It seems to be an unbeautiful object.

Accordingly, the present invention is to provide an improvement relating to the above-mentioned decorative apparatus, which will be a pretty decoration whenever in the daytime or at night.

### BRIEF DESCRIPTION OF THE DRAWINGS

The following drawings indicate the character and improvement of the present invention.

FIG. 1 is a perspective view of a conventional patterned apparatus.

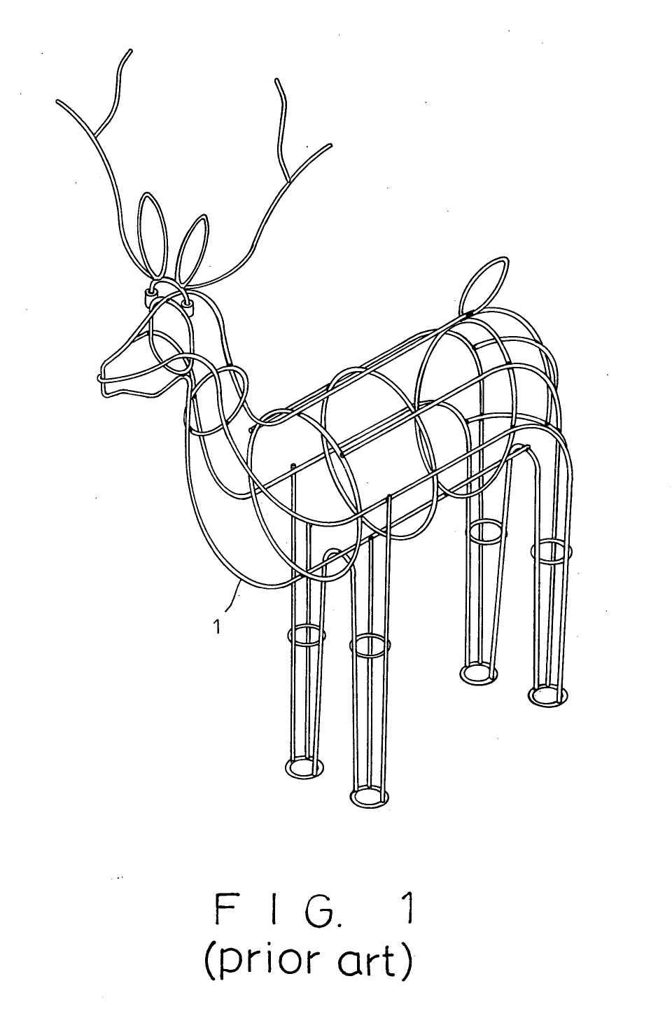

FIG. 2 is a perspective view of FIG. 1 connecting with bulb assemblies thereon.

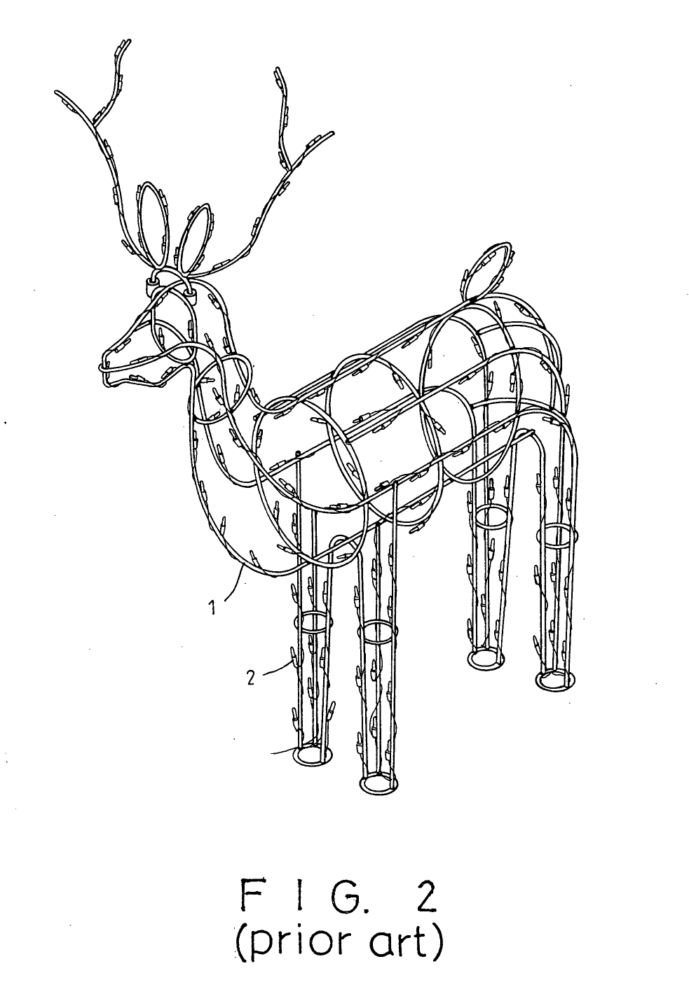

FIG. 3 is a perspective view of a decorative patterned apparatus according to the present invention.

### DETAILED DESCRIPTION OF THE INVENTION

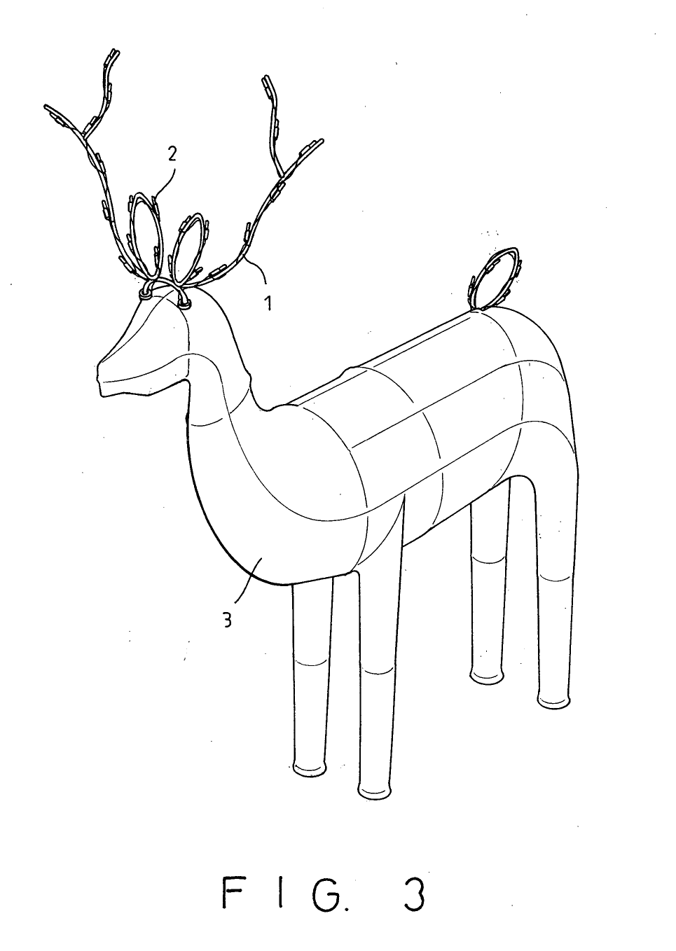

Referring to FIG. 3, the present invention relates to a decorative patterned apparatus, which includes a basic patterned frame composed by rods (1) and connected with bulb assemblies (2) at interval. The improvement of the present invention is to provide a colorful layer (3) to cover the patterned frame. The colorful layer (3) is penetrable to light. Hence, in the daytime, the patterned frame with colorful layer (3) can display its original construction for decorative effect. At night, the light of the bulb assemblies (2) can penetrate the cover on the patterned frame, which is then shown with special performance.

Accordingly, the decorative patterned apparatus of the present invention can provide the special decorative lighting effect in the daytime as well as at night. It obtains utility for use and should be allowed for patent.

1. A decorative patterned apparatus including a basic patterned frame composed by rods and connected with bulb assemblies at interval; and the improvement is to provide a colorful layer to cover the patterned frame, wherein the colorful layer is penetrable to light.
